(19) United States
(12) Patent Application Publication
(10) Pub. No.: US 2016/0139414 A1
(43) Pub. Date: May 19, 2016

(54) INFORMATION PROCESSING METHOD AND WEARABLE DEVICE

(71) Applicants: Beijing Lenovo Software Ltd., Beijing (CN); Lenovo (Beijing) Limited, Beijing (CN)

(72) Inventor: Ben Xu, Beijing (CN)

(21) Appl. No.: 14/667,926

(22) Filed: Mar. 25, 2015

(30) Foreign Application Priority Data
Nov. 17, 2014 (CN) 201410653548.6

(51) Int. Cl. G02B 27/01; G06F 3/01

(52) U.S. Cl. CPC G02B 27/0176; G06F 3/011

(57) ABSTRACT

The present disclosure discloses an information processing method and wearable device. The method comprises: acquiring first action data of a first part of a user, by using a first wearable device worn on the first part of a user; and transmitting the first action data to a second wearable device worn on a second part of the user, wherein the second wearable device is capable of modifying information that is presented to the user in accordance with the first action data acquired by the first wearable device.

### CROSS-REFERENCE TO RELATED APPLICATION(S)

This application claims priority to the Chinese Patent Application No. 201410653548.6, filed on Nov. 17, 2014, entitled “INFORMATION PROCESSING METHOD AND WEARABLE DEVICE” which is incorporated herein by reference in its entirety.

### TECHNICAL FIELD

The present disclosure relates to the field of electronic technology, and in particular, to an information processing method and a wearable device.

### BACKGROUND

With the continuous development of science and technology, the virtual reality technology has drawn more and more attention. By simulating a virtual world, a user would have an immersive experience and observe the virtual world without out limitation. As the virtual reality becomes increasingly popular, many virtual reality devices emerge as the times require, for example, head-mounted devices such as smart glasses, smart helmets or the like which are used to display the virtual world scene.

Currently, the head-mounted devices used to display the virtual scene can only detect rotation of the user's head, and cannot detect movement of the user's body. Therefore, switching of virtual scenes can only be achieved through motions of a user's head, and the user cannot really feel like walking in the virtual scene by walking. In order to solve this problem, a large treadmill is usually used as a data collection device in the related art to control the movement of the user in the virtual scene.

By taking the large treadmill as an example, in the related art, a process of controlling the movement of the user in the virtual scene is as follows. A user wears a head-mounted display device on his/her head and stands on the treadmill, and the treadmill is started to allow the user to walk. The treadmill has a data collection apparatus and a data transmission apparatus disposed thereon, to collect the walking information of the user and transmit the information to the head-mounted device, thereby achieving walking in the virtual scene.

The inventor of the present disclosure discovers the following technical problems in the process of implementing the technical solutions according to the embodiments of the present disclosure.

In the related art, since a device capable of enabling the user to really feel like moving in the virtual scene is a large treadmill which has a large volume and needs to be placed in a large space, there is a technical problem in the related art that the data collection device is not portable.

In the related art, since a device capable of enabling the user to really feel like moving in the virtual scene is a large treadmill which has high manufacturing cost, there is a technical problem in the related art that the data collection device has a high cost.

In the related art, since a device capable of enabling the user to really feel like moving in the virtual scene is a large treadmill which has a principle of judging whether the user moves by detecting the user's action, but detection accuracy of the large treadmill is usually not high, if amplitude of the movement action is small, the movement action will not be detected. Thus, there is a technical problem in the related art that the data collection device cannot accurately capture the movement action data of the user's movement action and thus cannot accurately control the movement of the user in the virtual scene.

### SUMMARY

The embodiments of the present disclosure provide an information processing method and a wearable device, to solve the technical problem in the related art that the data collection device is not portable, and achieve the technical effect of conveniently collecting the data.

In an aspect, an embodiment of the present disclosure provides an information processing method. The method comprises: acquiring first action data of a first part of a user, by using a first wearable device worn on the first part of a user; and transmitting the first action data to a second wearable device worn on a second part of the user, wherein the second wearable device is capable of modifying information that is presented to the user in accordance with the first action data acquired by the first wearable device.

In another aspect, an embodiment of the present disclosure further provides a wearable device. The wearable device comprises: a data collection unit configured to acquire first action data of a first part of a user, by wearing the wearable device on the first part of the user; and a data transmission unit configured to transmit the first action data to another wearable device worn on a second part of the user, wherein the other wearable device is capable of modifying information that is presented to the user in accordance with the first action data acquired by the wearable device.

In another aspect, an embodiment of the present disclosure further provides a wearable device. The wearable device comprises: a display unit; a data reception unit configured to receive first action data of a first part of a user from another wearable device worn on the first part of the user; and a data processing unit configured to modify a virtual scene displayed by the display unit in accordance with the first action data acquired by the wearable device.

### BRIEF DESCRIPTION OF THE DRAWINGS

In order to illustrate technical solutions in the embodiments of the present disclosure or in the related art more clearly, accompanying drawings needed to be used in the description of the embodiments or the related art will be described below in brief. Obviously, the accompanying drawings described below are merely the embodiments of the present disclosure. A person having ordinary skill in the art can further obtain other accompanying drawings according to these accompanying drawing without contributing any creative labor.

FIG. 1 is a flowchart of an information processing method according to a first embodiment of the present disclosure.

FIG. 2 is a flowchart of an information processing method according to a second embodiment of the present disclosure.

FIGS. 3A-3B are diagrams of a second implementation of step S202 in the information processing method according to the second embodiment of the present disclosure.

FIGS. 4A-4B are diagrams of a third implementation of step S202 in the information processing method according to the second embodiment of the present disclosure.

FIGS. 5A-5B are diagrams of a fourth implementation of step S202 in the information processing method according to the second embodiment of the present disclosure.

FIGS. 6A-6B are diagrams of adjusting a virtual scene by a first wearable device and a second wearable device in the information processing method according to the second embodiment of the present disclosure.

FIG. 7 is a structural block diagram of a wearable device according to a third embodiment of the present disclosure.

FIG. 8 is a structural block diagram of a wearable device according to a fourth embodiment of the present disclosure.

### DETAILED DESCRIPTION

The embodiments of the present disclosure provide an information processing method and a wearable device, to solve the technical problem in the related art that the data collection device is not portable, and achieve the technical effect of conveniently collecting the data.

In order to solve the above technical problem, the general concept of the technical solutions according to the embodiments of the present application is as follows.

In an aspect, the present disclosure provides an information processing method applied in a first wearable device capable of implementing data interaction with a second wearable device, wherein the first wearable device is worn on a first part of a user and the second wearable device is worn on a second part of the user which is different from the first part, the method comprising: when a first extremity corresponding to the first part performs a first extremity action, acquiring first extremity action data corresponding to the first extremity action; and transmitting the first extremity action data to the second wearable device.

In another aspect, the present disclosure provides an information processing method applied in a second wearable device including at least a first display unit which can present a virtual scene and being capable of implementing data interaction with the first wearable device, wherein the first wearable device is worn on a first part of a user and the second wearable device is worn on a second part of the user which is different from the first part, the method comprising: receiving first extremity action data transmitted by the first wearable device, wherein the first extremity action data represents action information of a first extremity corresponding to the first part; and changing the virtual scene which is currently displayed by the first display unit based on the first extremity action data.

In the above technical solutions, data is collected through the wearable device instead of detecting the data by the large-scale device such as a large treadmill in the related art. As the wearable device occupies a small volume and is convenient to use, the technical problem in the related art that the data collection device is not portable is solved and the technical effect of conveniently collecting the data is achieved.

For better understanding the above technical solutions, the technical solutions of the present disclosure will be described in detail below in conjunction with accompanying drawings and specific embodiments. It should be understood that embodiments in the present disclosure and specific features in the embodiments are used to set forth the technical solutions of the present disclosure in detail, instead of limiting the technical solutions of the present disclosure. Without a conflict, the embodiments in the present disclosure and the technical features in the embodiments can be combined with each other.

### First Embodiment

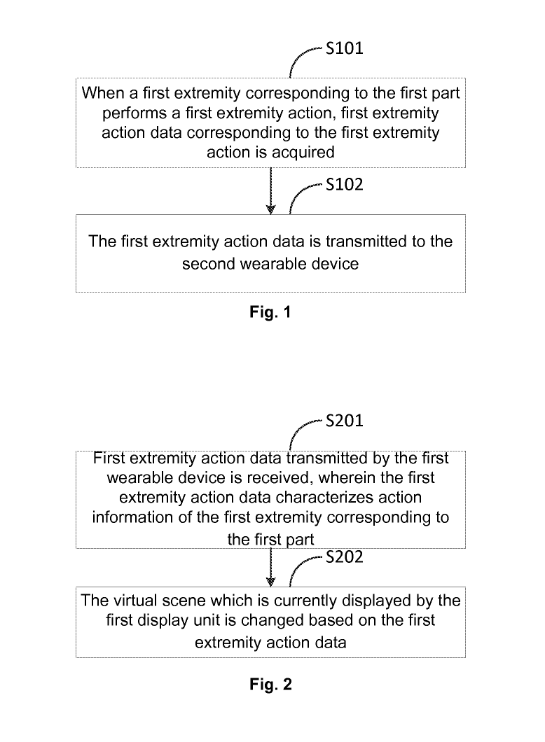

As shown in FIG. 1, an embodiment of the present disclosure provides an information processing method applied in a first wearable device capable of implementing data interaction with a second wearable device, wherein the first wearable device is worn on a first part of a user and the second wearable device is worn on a second part of the user which is different from the first part. The method comprises the following steps.

In S101, when a first extremity corresponding to the first part performs a first extremity action, first extremity action data corresponding to the first extremity action is acquired.

In S102, the first extremity action data is transmitted to the second wearable device.

In a specific implementation, the first part may be feet, legs, or the like, and the second part may be head or eyes. Of course, the first part and the second part may also be other parts, which will not be enumerated here. In the present embodiment, the implementation of the method according to the embodiment of the present disclosure will be described in detail by taking the first part being feet and the second part being eyes as an example.

When the first part is feet, the first wearable device may be smart shoes, and when the second part is eyes, the second wearable device may be smart glasses or smart helmet.

Firstly, step S101 will be performed. In step S101, when a first extremity corresponding to the first part performs a first extremity action, first extremity action data corresponding to the first extremity action is acquired. The specific implementation is as follows.

The first extremity action data corresponding to the first extremity action is acquired by at least an action sensor arranged in the first wearable device. The first extremity action data further comprises one of height variation data, acceleration variation data, posture variation data, and distance variation data of the first extremity or a combination thereof.

In a specific implementation, in order to detect the action of the feet so as to acquire action data corresponding to the feet, i.e., the first extremity action data, the first wearable device has at least an action sensor installed thereon, such as a gyroscope, a distance sensor, a direction sensor or the like. Those skilled in the art can set a corresponding sensor according to the action data which is actually collected, which is not limited in the present disclosure.

Still by taking the above example, when the user is walking with the smart shoes worn, the distance sensor will detect the displacement of the user in real time, and transmit displacement data to the second wearable device. If the user turns around, for example, turns left, the direction sensor will detect amplitude of left-turn of the user, and transmit the amplitude of left-turn to the second wearable device. Walking habits may be preset to detect whether the user goes forward or falls back. For example, the walking habits may be preset as follows: if the heel firstly lands on the ground, it represents that the user goes forward, and if the tiptoe firstly lands on the ground, it represents that the user falls back.

Communication between the first wearable device and the second wearable device may be achieved in a wired or wireless manner. The first wearable device may continuously transmit data to the second wearable device, or may periodically transmit data to the second wearable device. Those skilled in the art can set the period in which the data is periodically transmitted according to practical requirements, which is not limited in the present disclosure. In addition, the first wearable device and the second wearable device may transmit the collected data to the intelligent devices such as a mobile phone, a computer or the like, to acquire interactive information between the first wearable device and the second wearable device in real time.

### Second Embodiment

As shown in FIG. 2, another embodiment of the present disclosure provides an information processing method applied in a second wearable device including at least a first display unit which can present a virtual scene and being capable of implementing data interaction with the first wearable device, wherein the first wearable device is worn on a first part of a user and the second wearable device is worn on a second part of the user which is different from the first part. The method comprises the following steps.

In S201, first extremity action data transmitted by the first wearable device is received, wherein the first extremity action data represents action information of the first extremity corresponding to the first part.

In S202, the virtual scene which is currently displayed by the first display unit is modified based on the first extremity action data.

In a specific implementation, the implementation of the method according to the embodiment of the present disclosure will be described in detail still by taking the first part being feet, the first wearable device being smart shoes, the second part being eyes, and the second wearable device being smart glasses as an example.

Firstly, step S201 is performed. In step S201, first extremity action data transmitted by the first wearable device is received, wherein the first extremity action data represents action information of the first extremity corresponding to the first part.

In the embodiment of the present disclosure, the smart glasses may display a virtual 3D scene, and the user may observe the virtual scene in a first-person perspective when using the smart glasses. After the first wearable device, i.e., the smart shoes collect one of height variation data, acceleration variation data, posture variation data, and distance variation data of the first extremity, or a combination thereof, the first wearable device transmits the collected action data to the second wearable device in a wired or wireless manner. For example, when the user is walking, with the smart shoes worn, at a uniform speed in a straight line, the smart shoes collect and transmit the speed at which the user is walking or real-time displacement variation data to the smart glasses; and if the user jumps, the smart shoes collect and transmit the height and acceleration of the jump to the smart glasses, for process by the smart glasses in the next step.

After step S201 is performed, step S202 will then be performed. In step S202, the virtual scene which is currently displayed by the first display unit is modified based on the first extremity action data. There are four implementations of step S202 as follows.

In a first implementation, when the first extremity action data is the acceleration variation data, the virtual scene which is currently displayed by the first display unit is modified based on the acceleration variation data, wherein amplitude of variation in the virtual scene is in a positive correlation relationship with amplitude of acceleration variation.

In a specific implementation, the smart glasses may modify the virtual 3D scene according to the data transmitted by the smart shoes. For example, if a user is running, with the smart shoes worn, at a uniform speed of 3 m/s, the smart glasses control the displayed 3D scene to moving forward at a uniform speed of 3 m/s as well; if the user is running, with the smart shoes worn, at a fixed acceleration of 2 m/s², the smart glasses control the 3D scene to modify at an acceleration of 2 m/s² as well; and if the user is running, with the smart shoes worn, at a variable acceleration, for example, an acceleration of 2 m/s² during first 30 seconds and 1 m/s² during the rest of time, the smart glasses adjust the acceleration of variation in the virtual scene in real time according to the variation in the acceleration.

In a second implementation, when the first extremity action data is the distance variation data, it is judged whether the distance variation data meets a preset distance condition to acquire a first judgment result; and when the judgment result is YES, the virtual scene which is currently displayed by the first display unit is modified based on the preset distance condition.

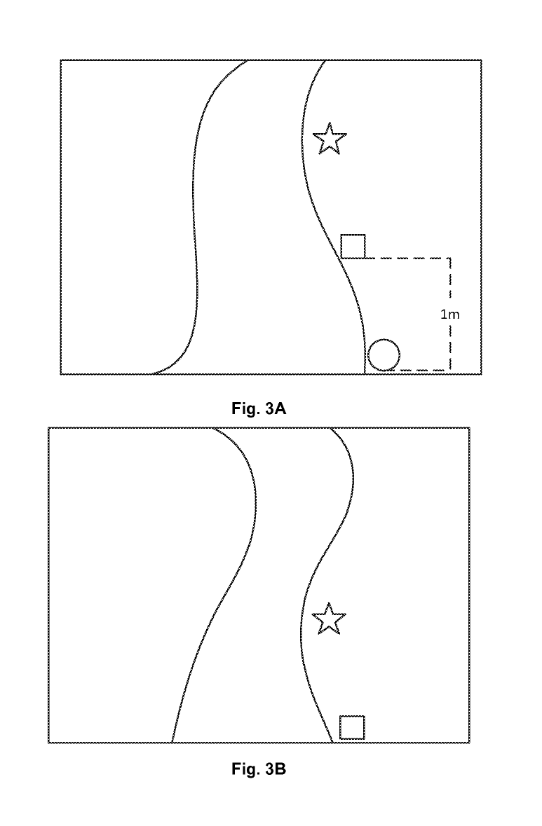

Still by taking the above example, when the smart shoes detect a change in the displacement, for example, the user goes forward or falls back, the smart shoes transmit the displacement variation to the smart glasses to adjust the 3D virtual scene. As shown in FIG. 3A, illustrated is a scene which is currently displayed by the smart glasses, which is a road. There are three objects placed on the roadside, i.e., a circular object, a square object, a star object, and a linear distance between the circular object and the square object is 1 m. If a user currently walks a linear distance of 1 m along the road, the virtual scene is correspondingly adjusted to the scene shown in FIG. 3B, i.e., the virtual scene is also adjusted by 1 m. That is, the user walks to the position where the square object is located in the virtual scene, and observes the scene shown in FIG. 3B.

In addition, when the smart glasses receive displacement variation, the smart glasses firstly judge whether the displacement variation is greater than a minimum accuracy required for adjusting the virtual scene. If the accuracy required for adjusting the virtual scene displayed by the smart glasses is high, even if the displacement variation collected by the smart shoes is small such as 1 cm, the virtual scene may also be adjusted by 1 cm. As when the displacement variation is small, a modification of the scene observed by the user may not be obvious, a preset threshold may be set, for example, 5 cm or 10 cm, and when the displacement variation is less than the threshold, the virtual scene will not be adjusted, and only when the displacement variation is greater than the threshold, the displacement variation cause a modification in the scene.

In a specific implementation, the adjustment amplitude of the distance variation data may be in a one-to-one correspondence relationship with that of the virtual scene. That is, if the distance is changed by an amount, the virtual scene will be adjusted by the same amount. Of course, the distance variation data and the adjustment amplitude of the virtual scene may meet a rule or algorithm. For example, when a ratio between the distance variation data and the adjustment amplitude of the virtual scene is 2:1, if the distance is changed by 2 m, the scene will be correspondingly adjusted by 1 m. Those skilled in the art can set the accuracy and the algorithm or rule according to practical requirements, which is not limited in the present disclosure.

In a third implementation, when the first extremity action data is the height variation data, a corresponding height adjustment relationship between the height variation data and the virtual scene is acquired; and the virtual scene which is currently displayed by the first display unit is modified based on the corresponding height adjustment relationship.

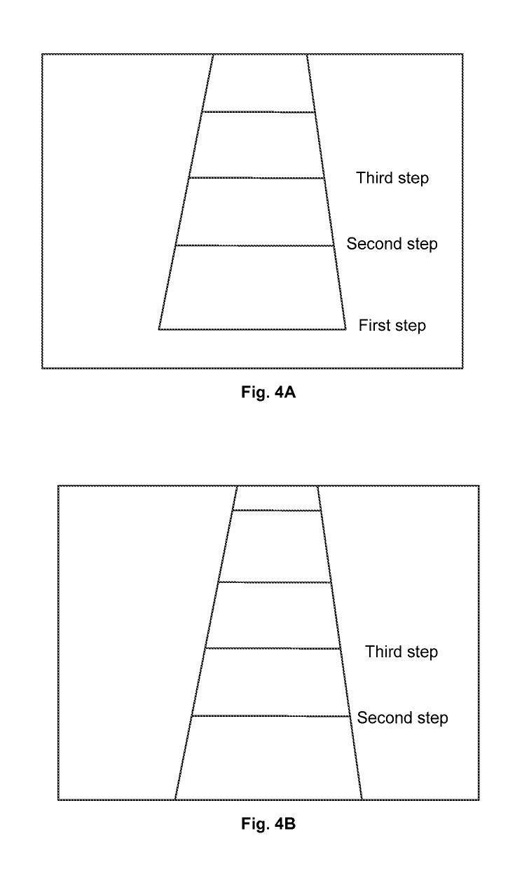

Still by taking the above example, as shown in FIG. 4A, when a 3D virtual scene presented by the current smart glasses is a flight of stair steps and a user is required to perform an action of climbing the steps with the smart shoes worn, height data of the user's foot which is lifted is firstly collected, and the virtual scene is adjusted according to a correspondence relationship between the height data which is actually collected and the height variation of the virtual scene. The correspondence relationship may be a one-to-one correspondence relationship, or may also meet a predetermined rule. For example, when a ratio between the real height data and the height of the scene is 1.5:1, if the height of the foot which is lifted is 15 cm, the scene is correspondingly adjusted by 10 cm. Alternatively, the scene may also be adjusted according to a number of lifting the user's feet. For example, when the user climbs the steps in the virtual scene, if the user lifts a foot once, it is considered that the user climbs one step by default, and when the user drops the foot and lifts the other foot, it is considered that the user climbs a second step by default. FIG. 4B illustrates a scene which is observed by the user through the virtual glasses when the user climbs one step by lifting the foot once, which is the same as that when the user climbs the steps in the real environment. Of course, those skilled in the art can set the height adjustment of the scene according to practical requirements, which is not limited in the present disclosure.

In a fourth implementation, when the first extremity action data is the posture variation data, the virtual scene which is currently displayed by the first display unit is modified based on the posture variation data, wherein amplitude of variation in the virtual scene is in a positive correlation relationship with amplitude of posture variation.

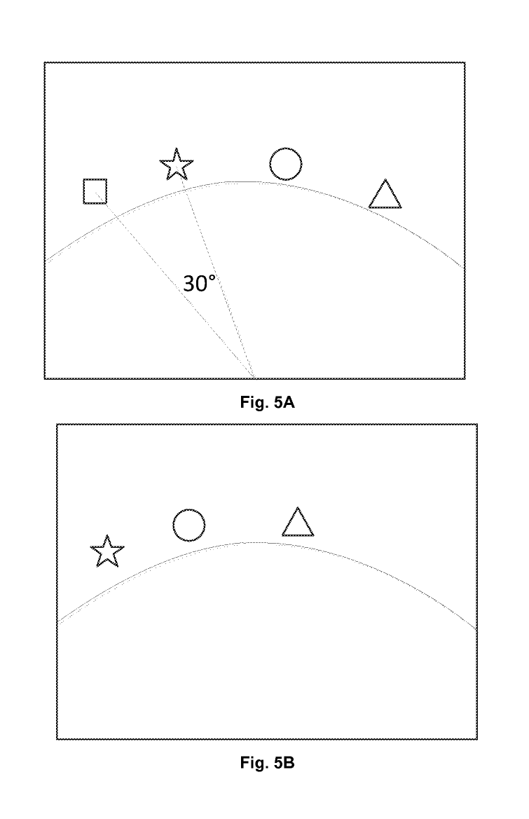

Still by taking the above example, the posture variation data may be turn-around data, state variation of the tiptoe or heel, or the like. When the user turns around, as shown in FIG. 5A, the scene displayed by the display unit before the user turns around is shown in FIG. 5A, and the user may observe that there are four objects in the front, i.e., a square object, a star object, a circular object, and a triangular object respectively, and an angle between a line from the square object to the place where the user is located and a line from the star object to the place is 30 degrees. In this case, if the user turns right 30 degree, the displayed scene also turns right 30 degrees, and at this time, the scene observed by the user is shown in FIG. 5B. In a specific implementation, the turn-around direction may be acquired by detecting a direction to which the tiptoe points. In addition, the rule may be set as follows: if the tiptoe firstly lands on the ground, it represents that the user falls back, and if the heel firstly lands on the ground, it represents that the user goes forward. The action may be set according to user's habits, for example, if the tiptoe firstly lands on the ground, it may represent that the user goes forward, which is not limited in the present disclosure.

In the four implementations as described above, the virtual scene is adjusted according to certain data. Of course, in a specific implementation, the data may be a combination of the above data. For example, when a user turns a corner in the process of walking, the collected data is distance variation data and posture variation data, and the smart shoes transmit the two kinds of data to the smart glasses. The smart glasses process the two kinds of data at the same time, and adjust the distance and direction of the virtual scene. In this case, the adjustment process is in accordance with the user's action, i.e., when the user is walking, the distance of the scene is adjusted, and when the user starts to turn a corner, the scene is turned around at the same time, so that the user feels like walking and turning a corner in the virtual scene. Thus, the adjustment of the virtual scene by the smart glasses is synchronous with the user's action, and thus the user can intuitionally feel like moving in the virtual scene.

In addition to receiving the data transmitted by the smart shoes, the embodiment of the present disclosure further comprises the following steps.

In a first step, second extremity action data detected by the second wearable device is acquired, wherein the second extremity action data represents action information of the second extremity corresponding to the second part.

In a second step, the virtual scene which is currently displayed by the first display unit is modified based on the first extremity action data and the second extremity action data.

Still by taking the above example, the smart glasses have a sensor apparatus installed thereon, which may collect action information of the head, such as an up-and-down motion, a left-and-right motion of the head or the like. The smart glasses receive the action data of the feet transmitted by the smart shoes, collect the motion data of the head at the same time, and adjust the virtual scene by combining the action data of the feet and the motion data of the head.

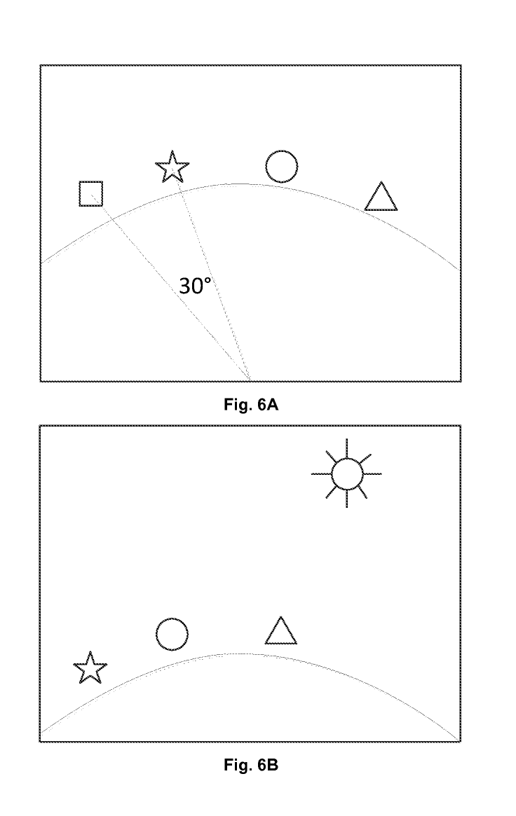

For example, when the user lowers his/her head while wearing the smart glasses, the virtual scene is correspondingly adjusted to a scene below the original scene, and when the user raises his/her head, the virtual scene is correspondingly adjusted to a scene above the original scene. Before the user turns around while wearing the smart shoes and the smart glasses, the presented virtual scene is shown in FIG. 6A, and an angle between the line from the square object to the place where the user is located and the line from the start object to the place is 30 degree. In this case, if the user turns right 30 degrees and maintains his/her head raised in the whole turn-around process, the scene above the original scene in the virtual scene is turned around 30 degrees, and the presented scene after the user turns around is shown in FIG. 6B. Thus, the virtual scene may be adjusted by combining the first wearable device and the second wearable device.

### Third Embodiment

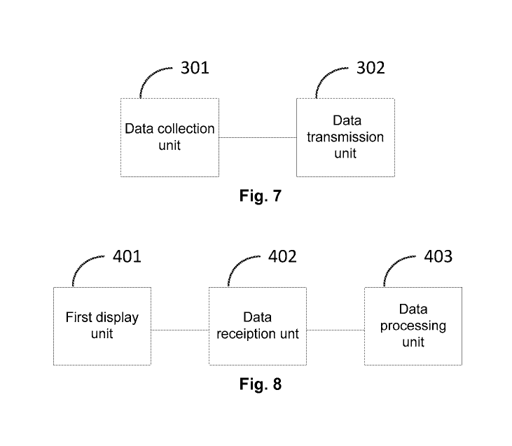

Based on the same inventive concept, the third embodiment of the present disclosure further provides a wearable device corresponding to the method according to the first embodiment. As shown in FIG. 7, the wearable device can implement data interaction with the second wearable device, wherein the wearable device is worn on a first part of a user and the second wearable device is worn on a second part of the user which is different from the first part, the wearable device comprising: a data collection unit 301 configured to, when a first extremity corresponding to the first part performs a first extremity action, acquire first extremity action data corresponding to the first extremity action; and a data transmission unit 302 configured to transmit the first extremity action data to the second wearable device.

The data collection unit 301 comprises at least an action sensor through which the first extremity action data corresponding to the first extremity action is acquired.

The first extremity action data further comprises one of height variation data, acceleration variation data, posture variation data, and distance variation data of the first extremity, or a combination thereof.

### Fourth Embodiment

The embodiment four of the present disclosure further provides a wearable device corresponding to the method according to the second embodiment. As shown in FIG. 8, the wearable device includes at least a first display unit 401 which can present a virtual scene and being capable of implementing data interaction with a first wearable device, wherein the first wearable device is worn on a first part of a user and the wearable device is worn on a second part of the user which is different from the first part, the wearable device comprising: a data reception unit 402 configured to receive first extremity action data transmitted by the first wearable device, wherein the first extremity action data represents action information of a first extremity corresponding to the first part; and a data processing unit 403 configured to modify the virtual scene which is currently displayed by the first display unit 401 based on the first extremity action data.

The first extremity action data further comprises one of height variation data, acceleration variation data, posture variation data, and distance variation data of the first extremity, or a combination thereof.

When the first extremity action data is the acceleration variation data, the data processing unit 403 is configured to modify the virtual scene which is currently displayed by the first display unit 401 based on the acceleration variation data, wherein amplitude of variation in the virtual scene is in a positive correlation relationship with amplitude of acceleration variation.

When the first extremity action data is the distance variation data, the data processing unit 403 is further configured to judge whether the distance variation data meets a preset distance condition to acquire a first judgment result; and when the judgment result is YES, modify the virtual scene which is currently displayed by the first display unit 401 based on the preset distance condition.

When the first extremity action data is the height variation data, the data processing unit 403 is further configured to acquire a corresponding height adjustment relationship between the height variation data and the virtual scene; and modify the virtual scene which is currently displayed by the first display unit 401 based on the corresponding height adjustment relationship.

When the first extremity action data is the posture variation data, the data processing unit 403 is further configured to modify the virtual scene which is currently displayed by the first display unit 401 based on the posture variation data, wherein amplitude of variation in the virtual scene is in a positive correlation relationship with amplitude of posture variation.

The wearable device further comprises: a data collection unit 404 configured to acquire second extremity action data detected by the wearable device, wherein the second extremity action data represents action information of the second extremity corresponding to the second part.

Correspondingly, the data processing unit 403 is further configured to modify the virtual scene which is currently displayed by the first display unit 401 based on the first extremity action data and the second extremity action data.

The above technical solutions according to the embodiments of the present disclosure provide at least the following technical effects.

Firstly, in the solutions according to the embodiments of the present disclosure, data is collected through the wearable device instead of detecting the data by the large-scale device such as a large treadmill in the related art. As the wearable device occupies a small volume and is convenient to use, the technical problem in the related art that the data collection device is not portable is solved and the technical effect of conveniently collecting the data is achieved.

Secondly, in the solutions according to the embodiments of the present disclosure, data is collected through the wearable device, which has lower cost than the large-scale device in the related art. Thus, the present disclosure solves the technical problem in the related art that the data collection device has high cost, and achieves the technical effect of reducing the production cost.

Thirdly, in the solutions according to the embodiments of the present disclosure, data is collected through the wearable device, which has higher accuracy of data collection than the large-scale device in the related art, and can even accurately capture a subtle action. Therefore, the present disclosure solves the technical problem in the related art that the data collection data cannot accurately capture the movement action data of the user's movement action and thus cannot accurately control the movement of the user in the virtual scene, and achieves the technical effect of accurately controlling the variation in the virtual scene by accurately collecting the data.

Those skilled in the art should appreciate that the embodiments of the present disclosure can be provided as methods, systems, or computer program products. Therefore, forms such as hardware-only embodiments, software-only embodiments, or embodiments combining software and hardware can be used in the present disclosure. In addition, forms such as a computer program product which is implemented on one or more of computer usable storage media (comprising but not limited to a disk memory, a CD-ROM, an optical memory etc.) with computer usable program codes can be used in the present disclosure.

The present disclosure is described with reference to the flowcharts and/or block diagrams of the methods, devices (systems) and computer program products according to the embodiments of the present disclosure. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or other programmable data processing devices to generate a machine. Thereby, the instructions executed by the processor of the computer or other programmable data processing devices generate means for implementing functions specified in one or more flows in the flowcharts and/or one or more blocks in the block diagrams.

These computer program instructions can also be stored in a computer readable memory capable of introducing a computer or other programmable data processing devices to operate in a particular mode. Thereby, the instructions stored in the computer readable memory generate an article of manufacture comprising instruction means for implementing functions specified in one or more flows in the flowcharts and/or one or more blocks in the block diagrams.

These computer program instructions can also be loaded onto a computer or other programmable data processing devices, so as to enable a series of operation steps to be performed on the computer or other programmable devices to generate a computer-implemented process. Thereby, the instructions executed on the computer or other programmable devices provide a step of implementing functions specified in one or more flows in the flowcharts and/or one or more blocks in the block diagrams.

Specifically, computer program instructions corresponding to the information processing method according to the first embodiment of the present disclosure may be stored on a storage medium such as an optical disk, a hard disk, a USB device etc. When the computer program instructions in the storage medium corresponding to the information processing method are read or executed by an electronic device, the following steps are performed: when a first extremity corresponding to the first part performs a first extremity action, acquiring first extremity action data corresponding to the first extremity action; and transmitting the first extremity action data to the second wearable device.

Alternatively, when computer instructions stored in the storage medium, which correspond to the step of acquiring first extremity action data corresponding to the first extremity action when a first extremity corresponding to the first part performs a first extremity action, are executed, the following steps are further performed: acquiring the first extremity action data corresponding to the first extremity action through at least an action sensor arranged in the first wearable device.

The first extremity action data further comprises one of height variation data, acceleration variation data, posture variation data, and distance variation data of the first extremity, or a combination thereof.

Specifically, computer program instructions corresponding to the information processing method according to the second embodiment of the present disclosure may be stored on a storage medium such as an optical disk, a hard disk, a USB device etc. When the computer program instructions in the storage medium corresponding to the information processing method are read or executed by an electronic device, the following steps are performed: receiving first extremity action data transmitted by the first wearable device, wherein the first extremity action data represents action information of a first extremity corresponding to the first part; and changing the virtual scene which is currently displayed by the first display unit based on the first extremity action data.

The first extremity action data further comprises one of height variation data, acceleration variation data, posture variation data, and distance variation data of the first extremity, or a combination thereof.

Alternatively, when computer instructions stored in the storage medium, which correspond to the step of changing the virtual scene which is currently displayed by the first display unit based on the first extremity action data when the first extremity action data is the acceleration variation data, are executed, the following steps are further performed: changing the virtual scene which is currently displayed by the first display unit based on the acceleration variation data, wherein amplitude of variation in the virtual scene is in a positive correlation relationship with amplitude of acceleration variation.

Alternatively, when computer instructions stored in the storage medium, which correspond to the step of changing the virtual scene which is currently displayed by the first display unit based on the first extremity action data when the first extremity action data is the distance variation data, are executed, the following steps are further performed: judging whether the distance variation data meets a preset distance condition to acquire a first judgment result; and

when the judgment result is YES, changing the virtual scene which is currently displayed by the first display unit based on the preset distance condition.

Alternatively, when computer instructions stored in the storage medium, which correspond to the step of changing the virtual scene which is currently displayed by the first display unit based on the first extremity action data when the first extremity action data is the height variation data, are executed, the following steps are further performed: acquiring a corresponding height adjustment relationship between the height variation data and the virtual scene; and changing the virtual scene which is currently displayed by the first display unit based on the corresponding height adjustment relationship.

Alternatively, when computer instructions stored in the storage medium, which correspond to the step of changing the virtual scene which is currently displayed by the first display unit based on the first extremity action data when the first extremity action data is the posture variation data, are executed, the following steps are further performed: changing the virtual scene which is currently displayed by the first display unit based on the posture variation data, wherein amplitude of variation in the virtual scene is in a positive correlation relationship with amplitude of posture variation.

Alternatively, when the computer program instructions in the storage medium corresponding to the information processing method are read or executed by an electronic device, after the step of receiving the first extremity action data transmitted by the first wearable device, the following steps are further performed: acquiring second extremity action data detected by the second wearable device, wherein the second extremity action data represents action information of a second extremity corresponding to the second part; and changing the virtual scene which is currently displayed by the first display unit based on the first extremity action data and the second extremity action data.

Although some embodiments of the present disclosure have been described, additional changes and modifications can be made to these embodiments by those skilled in the art upon learning the basic creative concepts. Therefore, the appended claims are intended to be construed as comprising the embodiments and all changes and modifications that fall into the scope of the present disclosure.

Obviously, those skilled in the art can make various modifications and variations to the present disclosure without departing from the spirit and scope of the present disclosure. Thus, if these modifications and variations of the present disclosure belong to the scope of the claims of the present disclosure and the equivalent technologies thereof, the present disclosure is also intended to include these modifications and variations.

What is claimed is:

1. An information processing method, comprising:
acquiring first action data of a first part of a user, by using a first wearable device worn on the first part of a user; and
transmitting the first action data to a second wearable device worn on a second part of the user, wherein the second wearable device is capable of modifying information that is presented to the user in accordance with the first action data acquired by the first wearable device.

2. The method according to claim 1, wherein the acquiring of the first action data further comprises:
acquiring the first action data through at least one action sensor disposed in the first wearable device.

3. The method according to claim 2, wherein the first action data comprises any one or combination of height variation data, acceleration variation data, posture variation data, and distance variation data of the first part of the user.

4. The method according to claim 1, wherein the second wearable device comprises a display unit to present a virtual scene to the user and the second wearable device is operable to modify the virtual scene in accordance with the first action data acquired by the first wearable device.

5. The method according to claim 4, wherein if the first action data is acceleration variation data, the modification of the virtual scene displayed by the display unit based on the first action data comprises:
changing the virtual scene displayed by the display unit based on the acceleration variation data, wherein amplitude of variation in the virtual scene is in a positive correlation relationship with amplitude of acceleration variation.

6. The method according to claim 4, wherein if the first action data is distance variation data, the modification of the virtual scene displayed by the display unit based on the first action data comprises:
judging whether the distance variation data meets a preset distance condition to acquire a first judgment result; and
if so, modifying the virtual scene displayed by the display unit based on the preset distance condition.

7. The method according to claim 4, wherein if the first action data is height variation data, the modification of the virtual scene displayed by the display unit based on the first action data comprises:
acquiring a corresponding height adjustment relationship between the height variation data and the virtual scene; and
modifying the virtual scene displayed by the display unit based on the corresponding height adjustment relationship.

8. The method according to claim 4, wherein if the first action data is posture variation data, the modification of the virtual scene displayed by the display unit based on the first action data comprises:
modifying the virtual scene displayed by the display unit based on the posture variation data, wherein amplitude of variation in the virtual scene is in a positive correlation relationship with amplitude of posture variation.

9. The method according to claim 4, further comprising: after the receiving of the first action data transmitted from the first wearable device by the second wearable device,
acquiring second action data detected by the second wearable device, wherein the second action data characterizes action information of the second part of the user; and
modifying the virtual scene displayed by the display unit based on the first action data and the second action data.

10. A wearable device, comprising:
a data collection unit configured to acquire first action data of a first part of a user, by wearing the wearable device on the first part of the user; and
a data transmission unit configured to transmit the first action data to another wearable device worn on a second part of the user, wherein the other wearable device is capable of modifying information that is presented to the user in accordance with the first action data acquired by the wearable device.

11. The wearable device according to claim 10, wherein the data collection unit comprises at least one action sensor through which the first action data of the first part of the user is acquired.

12. The wearable device according to claim 11, wherein the first action data comprises any one or combination of height variation data, acceleration variation data, posture variation data, and distance variation data of the first part of the user.

13. A wearable device, comprising:
a display unit;
a data reception unit configured to receive first action data of a first part of a user from another wearable device worn on the first part of the user; and
a data processing unit configured to modify a virtual scene displayed by the display unit in accordance with the first action data acquired by the wearable device.

14. The wearable device according to claim 13, wherein the first action data comprises any one or combination of height variation data, acceleration variation data, posture variation data, and distance variation data of the first part of the user.

15. The wearable device according to claim 14, wherein if the first action data is the acceleration variation data, the data processing unit is configured to modify the virtual scene displayed by the display unit based on the acceleration variation data, wherein amplitude of variation in the virtual scene is in a positive correlation relationship with amplitude of acceleration variation.

16. The wearable device according to claim 14, wherein if the first action data is the distance variation data, the data processing unit is further configured to judge whether the distance variation data meets a preset distance condition; and, if so, to modify the virtual scene displayed by the display unit based on the preset distance condition.

17. The wearable device according to claim 14, wherein if the first action data is the height variation data, the data processing unit is further configured to acquire a corresponding height adjustment relationship between the height variation data and the virtual scene; and modify the virtual scene displayed by the display unit based on the corresponding height adjustment relationship.

18. The wearable device according to claim 14, wherein if the first action data is the posture variation data, the data processing unit is further configured to modify the virtual scene displayed by the display unit based on the posture variation data, wherein amplitude of variation in the virtual scene is in a positive correlation relationship with amplitude of posture variation.

19. The wearable device according to claim 13, further comprising:
a data collection unit configured to acquire second action data detected by the wearable device, wherein the second action data characterizes action information of the second part of the user.

20. The wearable device according to claim 19, wherein the data processing unit is further configured to modify the virtual scene displayed by the display unit based on the first action data and the second action data.
